(19) United States
(12) Patent Application Publication
(10) Pub. No.: US 2020/0342447 A1
(43) Pub. Date: Oct. 29, 2020

(54) Method and system to generate revenue utilizing a software application and the transmittal of hashing algorithm data

(71) Applicant: Charles Jerry Waugh, JR., Huntsville, AL (US)

(72) Inventor: Charles Jerry Waugh, JR., Huntsville, AL (US)

(21) Appl. No.: 16/740,471

(22) Filed: Jan. 12, 2020

Related U.S. Application Data
(60) Provisional application No. 62/839,752, filed on Apr. 28, 2019.

(51) Int. Cl. G06Q 20/36; G06Q 40/04; G06Q 20/38; G06Q 40/02; G06Q 50/06; G06Q 30/02; G06F 8/65

(52) U.S. Cl. CPC G06Q 20/3672; G06Q 20/3678; G06Q 40/04; G06Q 20/381; G06Q 2220/00; G06Q 50/06; G06Q 30/0279; G06F 8/65; G06Q 40/02

(57) ABSTRACT

The present method and system, describes a practice for configuring a computer to run end user software applications, utilizing a portion of the end users computing power, to solve hashing algorithms for mining crypto currencies, and depositing them into a crypto currency account. The crypto currency account will be held by a company, person or group of people, hereinafter referred to as the “Entity.” The Entity will design the end user software application, to allow the end user to configure the amount of processing power allocated for mining the crypto currency. The more power the end user allows for mining the crypto currency, the more redeemable “tokens” the end user will generate for exchanging, or, purchasing additions for their software application, provided by the Entity.

### BACKGROUND OF THE INVENTION

The disclosure generally relates to computer tasks, and more specifically, to systems and methods for automated transmittal of hashing algorithm data over a network, as it relates to crypto currency, and, more particularly, to methods, and systems, for creating revenue for an Entity and value for an end user.

The Entity will author useful software applications, such as video games, which it may offer to the end user at no cost. The end user will in turn, select, set, and/or configure a portion of their computers computational power, to solve hashing algorithms for the purpose of mining the crypto currency. The software application will be configured to detect the amount of computer power the end user has allocated for mining the crypto currency, and calculate the appropriate amount of redeemable tokens to be distributed to the end user. The end user can then expend the redeemable tokens for additions and upgrades to their software application, provided by the Entity, or any other service provided by the Entity, item or offering as defined by the Entity.

The inventor recognizes that building revenue streams and profit are changing. With crypto currency gaining in popularity and momentum, the inventor has surmised that creating a revenue stream by offering end users free software, or low cost software, in exchange for a portion of their computers computational power, a viable revenue stream can be created based on solving hashing algorithms, or mining crypto currencies. These crypto currencies are deposited in to an account, and can be converted to fiat monies at a later date.

### SUMMARY OF THE INVENTION

An embodiment of the present invention provides a method and system for generating a revenue stream for an Entity, by providing a software application that subscribes a desired service or function to an end user. The end user will allow part of their computational power of their computer, to be diverted to mining crypto currency for the Entity, thereby creating a revenue stream for the Entity. The Entity will compensate the end user by providing them with a number of tokens based on their allowed mining computational power. The end user can spend the tokens on updates, upgrades, and other services or items the Entity offers, thereby creating a value to the end user.

### BRIEF DESCRIPTION OF DRAWINGS

FIG. 1 illustrates the flow of transactions from the end user's computer.

FIG. 2 illustrates the deeper processes and how they communicate with one another.

FIG. 3 illustrates how the user interface represents the mix of mining power versus the graphical display power in favor of graphics

FIG. 4 illustrates how the user interface represents the mix of mining power versus the graphical display power in favor of mining.

FIG. 5 shows the hardware graphics processor and the store UI for the end user.

### DETAILED DESCRIPTION OF THE INVENTION

The invention pertains to authoring software applications that provide a service or desired function to an end user. The software application is authored by the Entity. The end user installs the software application onto their computer. The software application provides a desirable service or function to the end user. The software application creates an additional value of service for the end user by providing a means to update or upgrade their software application. The Entity will recognize the end users contribution of computational power from their computer, as reported by the software application, and award the end user “tokens” for which an exchange can be made to update, upgrade, or otherwise compensate the end user for that computational power. The advantage of this method and system is, the end user never has to spend fiat currency to receive their goods. They need only allow the Entity to use a portion of their computer's computational power, to earn desired goods and services.

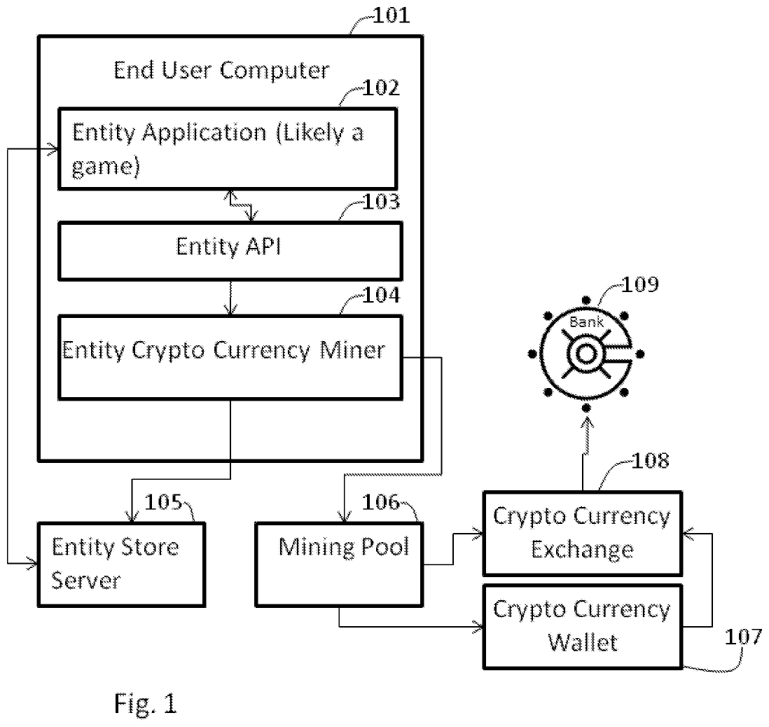

FIG. 1 denotes the end user computer 101, with the Entity's software application, 102, being executed there within. The Entity API, 103, provides a means to connect the Entity Application, 102, to the Entity Crypto Currency Miner, 104. The Crypto Currency Miner, 104, calculates the amount of mining power versus the amount of graphics processing power, set by the end user, and sends that data to the Entity Store Server, 105, over a network. The Entity Store Server, 105, uses the data from the Entity Crypto Currency Miner, 104, to award the End User with spendable tokens based on the End Users allowed mining power. From network communications between the Entity Store Server, 105, and the Entity Application, 102, the End User can observe how many tokens they have earned, and decide how to spend them. The tokens can be used to upgrade, update, augment or add to the Entity Application, 102. This part of the invention uses typical micro transaction, downloaded content, and user interface displays associate with computer applications, usually video games, that are well understood in the industry, and won't be explained here.

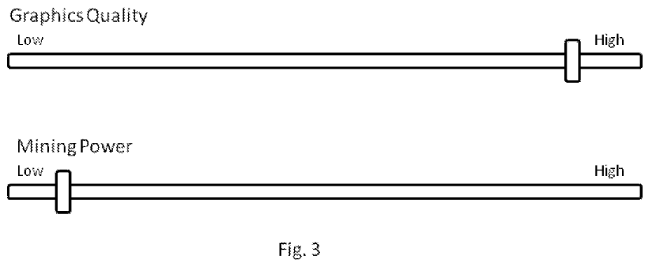

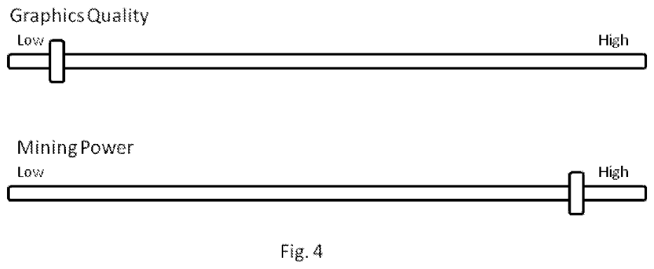

The Crypto Currency Miner, 104, also solves hashing algorithms, based on the amount of power allowed by the end user, for the purpose of mining crypto currency. The amount of power allowed for the mining of crypto currency, is controlled by mixing the graphical processing power with the mining power. This is accomplished through a Graphics Quality, FIG. 3, user interface. The Graphics Quality user interface will adjust proportionally between the amount of mining power and the amount of graphics power set by the end user. FIG. 3 shows the Graphics Quality user interface set in favor of graphics quality. FIG. 4 shows the Graphics Quality user interface set in favor of mining. The crypto currency algorithm solve rate is exchanged with a mining pool, FIG. 1, 106, and the number crypto currency, or, fractions of crypto currency, is calculated by the Mining Pool, 106.

The mined crypto currency from the Mining Pool, 106, can be transmitted to a Crypto Currency Wallet, 107, or to a Crypto Currency Exchange, 108, over a network. From the Crypto Currency Exchange, 108, the crypto currency can be traded to fiat currency and deposited into a Bank, 109. To trade crypto currency to fiat currency from a Crypto Currency Wallet, 107, it must first be transferred to a Crypto Currency Exchange, 108, over a network.

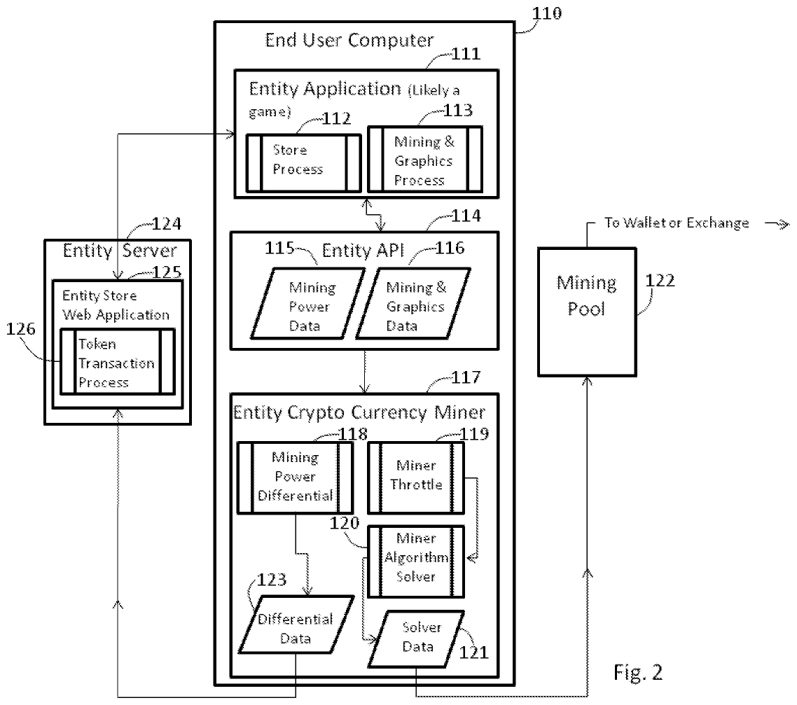

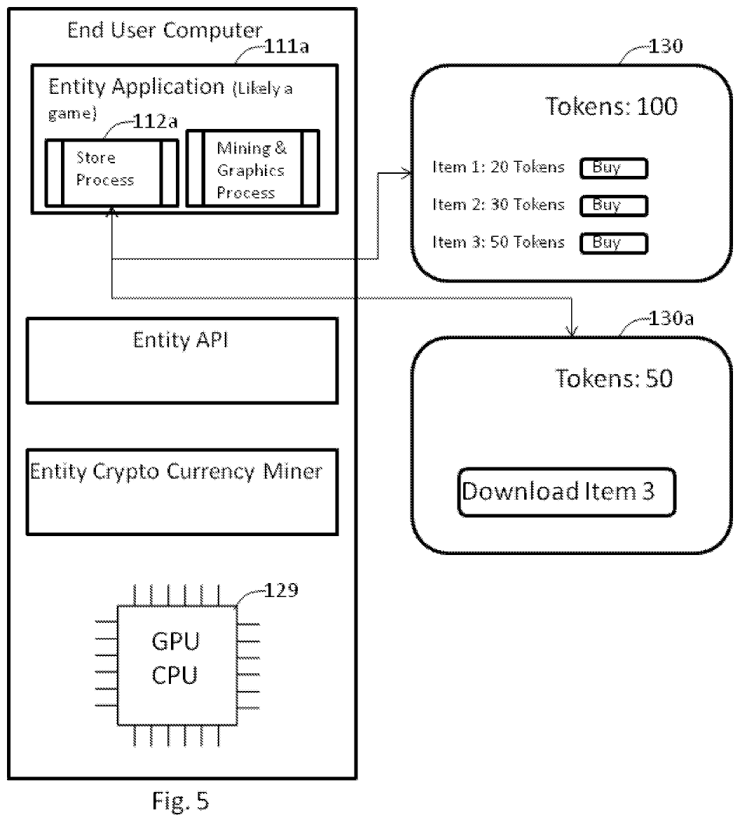

FIG. 2 denotes the sub processes, and further explains the invention. The Entity Application, 111, runs on the End User Computer, 110. The Mining and Graphics Processes, 113, communicates with the Entity API, 114, which allows the Mining and Graphics Processes, 113, to interface with the Entity Crypto Currency Miner, 117. The Entity Crypto Currency Miner, 117, computes a difference between the number of graphics processing cores allocated to the Entity Application, 111, for computing graphical data, and the number of graphics processing cores allocated to mining, by utilizing the Mining Power Differential, 118, sub process. The Mining Power Differential, 118, sub process, counts the maximum number of cores available on the Graphics Processing Unit (GPU) and or the Central Processing Unit (CPU) FIG. 5, 129, and compares how many graphics processing cores are being used for mining, with the total available. An algorithm used by the Mining Power Differential, FIG. 2, 118, derives a number as Differential Data, 123, and sends that data over a network to the Entity Server, 124. The Token Transaction Process, 126, uses the Differential Data, 123, to compute the number of tokens generated by the End User Computer, 110. The Entity Store Web Application, 125, stores the token information and associates it with the unique alpha numeric identifier generated by the Entity Application, 111, installed on the End User Computer, 110. The unique alpha numeric identifier can be the email address associated with the Entity Application, 111, during installation, a hardware MAC address, randomly generated alpha numeric, or other well known industry means of creating unique identifiers to associate the End User Computer, 110, with the Entity Server, 124. These are standard server/client relationships.

The available token amount, updates, upgrades, and additions to the Entity Application, 111, are transmitted over a network from the Entity Server, 124, to the End User Computer, 110. It is then processed and displayed to the end user from a Store UI, FIG. 5, 130, utilizing the Store Process, 112a. The end user may then execute a trade, using the earned tokens, from the Store UI, FIG. 5, 130, for any available updates, upgrades, items or additions to the Entity Application, 111a. The Store Process, FIG. 2, 112, transmits the trade data back to the Entity Server, 124, where it is processed by the Entity Store Web Application, 125, and subtracts the spent tokens from the previous total. The Entity Store Web Application, 125, then notifies the end user of the available downloadable content by transmitting that data back to the Entity Application, 111, executed on the End User Computer, 110. The downloadable content is displayed by utilizing the Store Process, 112, and displaying it to the end user from the Store UI, FIG. 5, 130a.

What is claimed is:

1. A computer system operated by an end user having installed a desirable software application developed and configured by the Entity, that generates crypto currency for the Entity, said system comprising:
Central Processing Unit (CPU); Graphics Processing Unit (GPU); memory; operating system; network adapter; internet connectivity; server client relationship; a software application comprising (a) a program that servers the interest of the end user (b) an API that allows the manipulation of graphics profiles to be differentiated between the graphical display quality and the mining capacity (c) executable program code that configures the CPU and GPU and memory to discover crypto currency through a mining process (d) executable program code that configures the CPU and network adapter to send information to a specified mining pool internet protocol address, or domain (e) a program code that when executed computes redeemable tokens for the end user, based on allowed mining power (f) a program code that when executed displays the redeemable tokens to the end user (g) a program code to calculate the amount of redeemable tokens, based on the allowed mining power (h) an executable program code that generates and stores the history and transactions of the redeemable tokens.

2. The system of claim 1, further comprising a method by which an Entity is compensated for the use of its software application by utilizing the computational power of the end users computer, said method comprising:
An end user operated computer, on which the Entity's software application is installed, sends crypto currency or mining computational data to a mining pool at varied rates set by the end user; said computational data rate is set by the end user by adjusting the number of CPU and GPU cores available to the crypto currency miner; mining pool accumulates the amount of crypto currency generated by the end user's computer using the Entity's crypto currency miner; mining pool sends the crypto currency to an exchange or wallet; crypto currency is converted to fiat monies by moving it from the wallet to an exchange, or, directly from the exchange to a traditional bank; end user is compensated for the use of their allowed computer's computational power by accumulating redeemable tokens; redeemable tokens are awarded to the end user based on the amount of computational power allowed for mining; the tokens are used by the end user to update, upgrade, and/or enhance the software application, provided by the Entity.

3. The system of claim 2, further utilizing the method to allow end users to mine crypto currency for the purpose of extending or funding the development of the Entity's software application, or other applications.
